(19) United States
(12) Patent Application Publication
(10) Pub. No.: US 2024/0250367 A1
(43) Pub. Date: Jul. 25, 2024

(54) MOUNTING DEVICE, ASSEMBLY ARRANGEMENT AND METHOD THEREFOR

(71) Applicant: ABACS GMBH, Dresden (DE)

(72) Inventors: Marco ZICHNER, Dresden (DE); Sebastian PRENGEL, Dresden (DE)

(21) Appl. No.: 18/562,154

(22) PCT Filed: May 18, 2021
(86) PCT No.: PCT/EP2021/063176

§ 371 Date: Nov. 17, 2023

(51) Int. Cl. H01M 50/244; H01M 10/42; H01M 50/213

(52) U.S. Cl. CPC H01M 50/244; H01M 10/4285; H01M 50/213

(57) ABSTRACT

The invention relates to an assembly arrangement with a mounting device, in particular for assembling a battery pack with battery cells, comprising: a robot interface for receiving the assembly device on an industrial robot, a cell interface for receiving battery cells from a conveyor, a cell aligner for aligning the battery cells in a specific position, an assembly effector for discharging the battery cells into the battery pack. Furthermore, the invention relates to a method for assembling a battery pack with battery cells.

The invention relates to mounting devices, assembly arrangements with such mounting devices and methods for mounting placement items in a target position, in particular a battery pack with battery cells.

Battery packs are used for various purposes—for example for stationary energy supply, for motor vehicles or for intermediate storage—which have standardized, in particular cylindrical, battery cells as energy storage units.

Such battery packs are available in a wide variety of designs with different numbers of battery cells, different battery voltages and storage capacities. The common feature of the known battery packs is that the large number of standardized battery cells must be separated according to the layout of the battery pack and inserted into a battery pack housing.

When assembling the battery cells in battery packs, particular attention must be paid to the polarity of the individual battery cells in the pack.

For this purpose, the battery cells are normally provided in packs in which the battery cells are already separated (for the purpose of assembly) and, above all, with a predetermined poll, so that an assembler can pick up the battery cell and assemble it with the desired poll. The battery cell is an assembly item. The pick-and-place machine can rely on the packaging in which the battery cell is present in the container.

However, the provision of the containers requires a lot of space in the assembly environment, which ultimately makes assembly cumbersome and expensive. This applies not only to battery cells, but to all kinds of placement items.

Against this background, one task of the invention is to improve a mounting process.

This task is solved by the objects of the independent claims. The dependent claims relate to corresponding further embodiments. In the following, various aspects and embodiments of these aspects are disclosed, which provide additional features and advantages.

A first aspect relates to a device, in particular for assembling a battery pack, configured to:
receiving a provided placement item (B), in particular battery cells;
applying an axial positioning force to the placement item (B) in order to convey the placement material to a target position (101), in particular in a battery cell receiver;
applying a radial guiding force to the placement item (B) in order to convey the placement item (B) to the target position (101);
applying the guiding force independently of the positioning force.

A mounting device can be any device that can move a placement item to a target position. For example, a pick-and-place device can be a pick-and-place device that transports battery cells into a cell receiver. A mounting device can also be a medical or analysis device that transports samples into a sample container. A mounting device can also be used in electrical engineering. In this context, mounting stands for the application of individual components such as resistors, diodes and other SMD components to the carrier material, e.g. a printed circuit board or a ceramic substrate. A placement material and a target position are determined by the application.

A positioning force is applied in such a way that a placement item is conveyed to the target position. An axial positioning force is applied at least partially along an axis that runs through the target position. In particular, the axial positioning force can be used to move the component along this axis into the target position. A positioning force can be applied in particular by a plunger, a hammer or a cam. A positioning force can also be applied by an end effector, for example a robot.

A guiding force is applied to guide the load into the target position. In particular, forces originating from the gravitational force and/or the positioning force are counteracted. The guiding force can also depend on the target position, especially if the target position is time-variant. In particular, several guiding forces can be generated. In particular, one guiding force or all guiding forces is less than one positioning force. In particular, a guiding force can be generated by a hose, a tube and/or one or more guide rails.

The advantage of this solution is that items can be loaded quickly and close together.

One embodiment of the first aspect relates to a device which is arranged to reduce the guiding force before the positioning force.

In particular, this can ensure that frictional forces on the unit applying the guiding force do not cause the placement item to be moved out of the target position again. For example, the guiding force can be applied by a snout, which is arranged between the target position and the device for applying the positioning force. If the placement material is now conveyed to the target position by the positioning force and the positioning force is reduced first, the placement material could “stick” in the trunk when it is moved and be unintentionally conveyed out of the target position again. This is avoided by ensuring that the positioning force remains on the placement material until the risk of unintentional adhesion to the snout has passed.

One embodiment of the first aspect relates to a device which is set up to check the one or more quality parameters of the placement item and, depending on the check, to apply the positioning force and/or the guiding force or to eject the placement item (B) from the placement device.

One embodiment of the first aspect relates to a device that is adapted to simultaneously inspect a plurality of simultaneously placed articles.

In particular, a simultaneous test comprises a temporally overlapping test of two placement items, e.g. so that a test of a second placement item begins when a test of a first placement item has not yet been completed.

One embodiment of the first aspect relates to a device that is configured to convey the placement item in a predetermined orientation to the target position.

A predetermined orientation can, in particular, include the electrical orientation. In particular, a plurality of components can be arranged in such a way that they have the same orientation. In particular, a plurality of component parts can be arranged in such a way that they have an unequal orientation; in particular, an orientation can be predetermined in such a way that a plurality of component parts, in particular battery cells, are arranged in alternating electrical orientation.

One embodiment of the first aspect relates to a device comprising a mechanically flexible connection for receiving the provided placement material.

One embodiment of the first aspect relates to a device, wherein the positioning force is applied non-uniformly in order to convey the placement material to the target position.

In particular, a positioning force can be applied in such a way that final positioning of the placement item is achieved by applying a positioning force to the placement item several times. In particular, the placement material can be ‘hammered’ into the target position by the positioning force.

One embodiment of the first aspect relates to a device which is set up to apply the guiding force by means of a guide sleeve and/or a guide rail, along which the placement item is conveyed by the positioning force, and wherein the guide sleeve and/or the guide rail is moved laterally relative to the target position to a position whose distance from the target position is less than a length of the placement item.

In particular, in the case of a narrow arrangement of a large number of components, this can ensure that a device for applying one or more guides jams with a component that has already been positioned. In particular, this can be achieved by moving the guide sleeve in a straight line towards the target position and parallel to the already mounted components. However, a lateral approach, which initially ends at a position where jamming can no longer occur and where the positioning force is then exerted, is advantageous in contrast.

According to a further aspect, a mounting device for assembling a battery pack with, in particular cylindrical, battery cells, for example of the type 18650, 20650 and/or 21700, is disclosed. The mounting device has:
(a) an interface, in particular for mounting the mounting device on an industrial robot, for example on a robot arm of an industrial robot]; and/or
(b) a cell interface for receiving battery cells from a conveyor; and/or
(c) a cell aligner for aligning, in particular individually (i.e. in particular only one battery cell at a time), the position of the battery cells, in particular those taken over by the conveyor means, in particular before the battery cell is discharged, in a specific, in particular a desired and/or intended, pole location (the term pole alignment can also be used synonymously); and/or
(d) a placement effector for discharging, in particular individually (i.e. in particular only one battery cell at a time), the battery cells, in particular taken over by the conveying means, into the battery pack, the discharge being effected by means of a positioning force, in particular axial, on the aligned battery cell; and/or
(e) a battery cell guide for applying a radial guiding force to the aligned battery cell.

The placement effector and the battery cell guide are set up to adjust the axial positioning force and the radial guiding force independently of each other. This can be done in particular as already explained in connection with the first aspect.

When using such an assembly device, the battery cells can be provided unsorted, in particular not sorted according to pole location. This means an enormous saving in the space required for the battery cells to be installed. This makes the provision of battery cells much easier and therefore cheaper, especially when assembling battery packs consisting of a large number of battery cells.

In addition, by aligning the battery cells on the placement device, i.e. on the robot arm, the placement can be carried out with a shorter cycle time because the travel distances between the individual placement locations—i.e. between two adjacent pick-up points for a battery cell—are minimized.

The advantages of the invention—both in terms of saving installation space and in terms of simplifying assembly and the effects of a possible reduction in cycle time—become all the more apparent the more battery cells have to be inserted into the battery pack to be assembled (per pack level but also overall).

Without the cell aligner, however, known solutions would either have to ensure in-sequence provision of the battery cells (with a precisely predetermined removal sequence from a cell layer, taking into account the required sequence of pole locations), or the placement device on the robot arm would have to cover large distances between the placement location and the cell store in order to supply itself with a correctly aligned battery cell in each case.

In one embodiment, the mounting device can form an integrated means with the cell aligner and the battery cell guide. This can then, for example, be moved by a robot as a positioning unit over a cell pick-up or battery pack in such a way that it can be quickly fitted with battery cells.

According to a further aspect, an assembly arrangement for assembling a battery pack with battery cells is disclosed. The assembly arrangement has:
(A) a cell store for the unorganized provision of the battery cells to be assembled, in particular at an assembly site; and/or
(B) a cell separator for the individual removal of the battery cells from the cell store; and/or
(C) a mounting device, in particular according to one embodiment of the invention, by means of which in particular the battery cells can be inserted individually into the battery pack; and/or
(D) an industrial robot with a robot arm for arranging and/or moving the placement device; and/or
(E) a conveying means for conveying the separated battery cells from the cell separator to the mounting device; and/or
(F) in particular, if the placement device does not have a cell aligner, a cell aligner for aligning the position of the battery cells, in particular individual battery cells, taken from the cell storage and/or the cell separator and/or the conveyor.

Such an assembly arrangement requires a much smaller installation space than known assembly arrangements, which require more space for the orderly provision of the battery cells to be assembled in a cell store for pole-aligned battery cells.

According to a further aspect, a method for equipping a battery pack with battery cells is disclosed, comprising the following method steps:
(i) provision, in particular unaligned and/or disordered provision, of the battery cells to be assembled, in particular in a cell store; and/or
(ii) Removal of individual and unaligned battery cells from the cell storage, in particular by means of a cell separator; and/or
(iii) conveying the removed, in particular separated and unaligned, battery cells from the cell separator to an assembly device, in particular by means of a conveyor; and/or
(iv) if necessary (in particular if it has been determined that the battery cell does not have a desired pole location) aligning the battery cells in a certain, in particular desired and/or intended pole location, in particular by means of a cell aligner; and/or
(v) discharging the aligned battery cell, in particular into the battery pack (in particular by means of an assembly device, which is designed in particular according to one embodiment of the invention) or into a reject store (in particular by means of an ejector), the discharge being effected by an axial force on the battery cells and the battery cells being guided into a target position by a radial force. The axial force and the radial force are independent of each other.

This can achieve an enormous saving in the space required for the battery cells to be installed. In particular, when assembling battery packs from a large number of battery cells, the provision of the battery cells is much simpler and therefore also cheaper.

The invention is based, among other things, on the idea of minimizing the travel distances during robot-based loading of a battery pack with standardized battery cells.

The disclosure thus provides, in particular, a technology for carrying out the alignment of the individual battery cells to be assembled with regard to the required pole position only on the placement device and thus preferably on the effector of the placement robot. One embodiment of the invention is based, among other things, on the idea of also carrying out any necessary quality tests of the individual battery cells on the placement device. With these ideas, the travel paths of the placement effector between the individual placement locations can be minimized; in addition, the individual battery cells can be provided in a completely unordered manner.

According to one embodiment, the mounting device has a test means for checking one or more electrical and/or electronic and/or structural-mechanical quality parameters of the battery cells to be removed.

In particular, electrical, structural-mechanical and/or geometric quality parameters can be considered, especially barcodes, internal resistance, internal impedance (i.e. DC and AC resistance), open-circuit voltage, polarity, weight, shape, geometric dimensions and/or mechanical resonance.

This makes it possible to provide untested battery cells because it can still be ensured during assembly that only battery cells that reach or exceed a predetermined quality are installed in the battery pack.

According to one embodiment, the test means is set up to test more than one, in particular two or three or four or more, battery cells simultaneously and/or overlapping in time.

This ensures that there is sufficient time to test each individual battery cell. If more time is available to test a battery cell, higher quality, more meaningful and/or more reliable tests can be carried out on the battery cell.

Even with a high cycle rate for filling the battery pack with individual battery cells, there can still be sufficient time to test an individual battery cell by decoupling the time available for the test from the cycle time so that, for example, 2, 3, 4 or 5 cycle times are available for the test. This can be achieved in particular by carrying out the tests overlapping, for example with a small intermediate storage area for the battery cells to be tested, which is filled with a new battery cell with each cycle time and from which a battery cell is removed with each cycle time. The time that each of the 2, 3, 4 or 5 battery cells, for example, spends in the small intermediate storage facility can then be used for the test.

According to one embodiment, the test means has a turret holder for the battery cells to be tested. The turret holder makes it easy to create a small intermediate storage facility for battery cells that can be continuously filled and emptied—particularly during the cycle time—and in which the battery cells can be tested for more than one cycle time. The turret holder can, for example, have a capacity of 2, 3, 4 or 5 battery cells.

According to one embodiment, the mounting device has a reject device for battery cells that have been sorted out, for example those that have not been tested in order (n.i.O.). This allows battery cells with an unsatisfactory test result to be sorted out.

According to one version, the ejection device is set up to feed the ejected battery cells to a reject store. This ensures that the discarded battery cells can be put to further use, for example in a battery pack with lower quality requirements for the battery cells used.

According to one embodiment, the discarding device is set up to direct the discarded battery cells to a specific one of several reject stores. In this way, the test result of the battery cells can be taken into account in a differentiated manner: for example, battery cells that can still be used in other battery packs with lower quality requirements can be separated from battery cells that are complete rejects based on the test result.

According to one embodiment, the cell aligner is arranged at a discharge position of the placement device. This makes it possible to align the battery cell's pole position with a minimum conveying path and thus supports a short placement cycle time. It also ensures that battery cells that have already passed a quality test are aligned, so that energy can be saved.

According to one embodiment, the cell aligner has a pole location detection system which, in particular in cooperation with a control unit of the placement device and/or the assembly arrangement, is set up to detect a ole location of the battery cell, in particular when the battery cell arrives at a discharge position, and/or to compare it with a ole location of the battery cell required at the intended placement position of the battery pack, and, if necessary, to carry out an alignment, in particular rotation, of the battery cell towards the required ole location.

A required position of a battery cell at an intended mounting location can be stored in the control unit of the mounting device and/or the assembly arrangement in a suitably professional manner, for example in a read-in mounting plan, which the control unit requires anyway for mounting the battery pack.

This ensures that only battery cells for which this is necessary with regard to the intended assembly are aligned.

According to one embodiment, the cell aligner is set up to rotate a battery cell, in particular a separated battery cell, in particular in a positionally accurate manner, about an axis which runs perpendicular to a longitudinal axis of the battery cell, and in particular intersects the longitudinal axis, in particular in or near the middle of a longitudinal extension of the battery cell.

This makes it possible to align the pole position of the battery cell in the smallest possible space, i.e. with the smallest possible installation space requirement. This is particularly desirable for an arrangement of the cell aligner on the robot arm.

According to one embodiment, the cell separator has a step conveyor. A step conveyor is capable of separating completely unsorted, in particular cylindrical, battery cells with great reliability and feeding them for further conveying in a suitably designed conveyor.

According to one embodiment, the conveying means has a hose, in particular one that is at least substantially stable in cross-section and/or flexible, for guiding the separated battery cells.

This makes it easy to feed the battery cells previously separated by the cell separator to the placement device. In particular, the hose takes into account the fact that the batteries are separated at the cell separator in a fixed position, while the batteries are required at the placement device in a flexible position, namely depending on the current position of the robot arm on which the placement device is arranged. Due to its flexible, but at the same time cross-sectionally stable design, the hose enables the battery cells to be conveyed in this way.

In particular, a filling device is provided at a transfer position between the cell separator and the conveyor. If, for example, the cell separator is designed with a step conveyor and the conveyor means with a hose, it can be provided that an insertion arrangement pushes a separated battery cell from the top step of the step conveyor into the hose at each cycle.

According to one embodiment, the cell storage system has an inclined plane and/or an inclination towards the cell separator. This ensures that more and more battery cells are fed to the cell separator without further manual or automatic intervention until the last battery cell provided in the cell store has been separated in the cell separator and conveyed further.

According to one embodiment, the assembly arrangement has one or more reject stores. In this way, the test result of the battery cells can be taken into account in a differentiated manner: for example, battery cells that can still be used in other battery packs with lower quality requirements can be collected. With several reject stores, for example, battery cells that can be reused can be separated from battery cells that are complete rejects based on the test result.

According to one embodiment, the method has the following method step: Checking one or more electrical and/or electronic and/or structural-mechanical quality parameters of the battery cells intended for assembly, in particular by means of a test agent.

This ensures that only battery cells with a sufficient quality are installed in the battery pack and/or that battery cells with a poorer quality can be used for other purposes.

According to one embodiment, a tested battery cell is assigned the test result “passed” and the battery pack is then fitted with this battery cell.

According to one embodiment, a tested battery cell is assigned the test result “failed” and the battery cell is then sent to a scrap store.

According to one embodiment, several levels of “failed” can be assigned, and the battery cell can then be forwarded to a reject store assigned to this level, depending on the assigned level.

In this way, different quality levels of the battery cells can be distinguished during testing and, depending on the quality level determined, can be installed in the battery pack or discarded in—possibly different—reject stores.

Further advantages and features result from the following embodiments, which refer to the figures. The figures do not show the embodiments to scale. The dimensions of the various features may be enlarged or reduced accordingly, in particular for clarity of description. For this purpose, partly schematized:

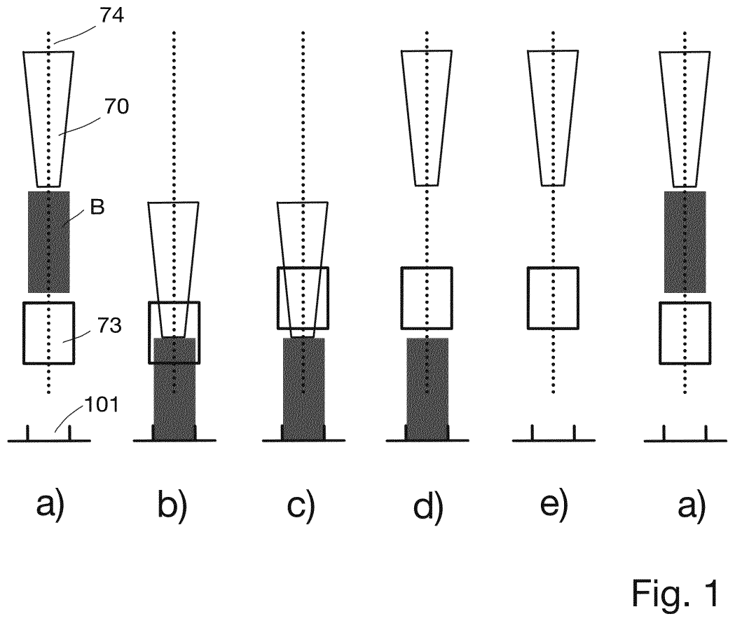

FIG. 1 shows a placement device in schematic view and in various states for positioning a placement item according to an embodiment of the present disclosure.

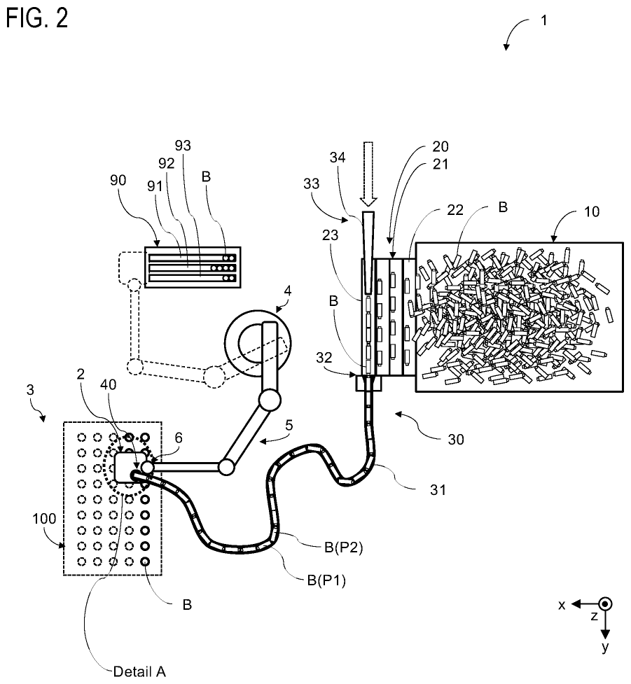

FIG. 2 shows a schematic view of an assembly arrangement according to an exemplary embodiment of the invention in a schematic view.

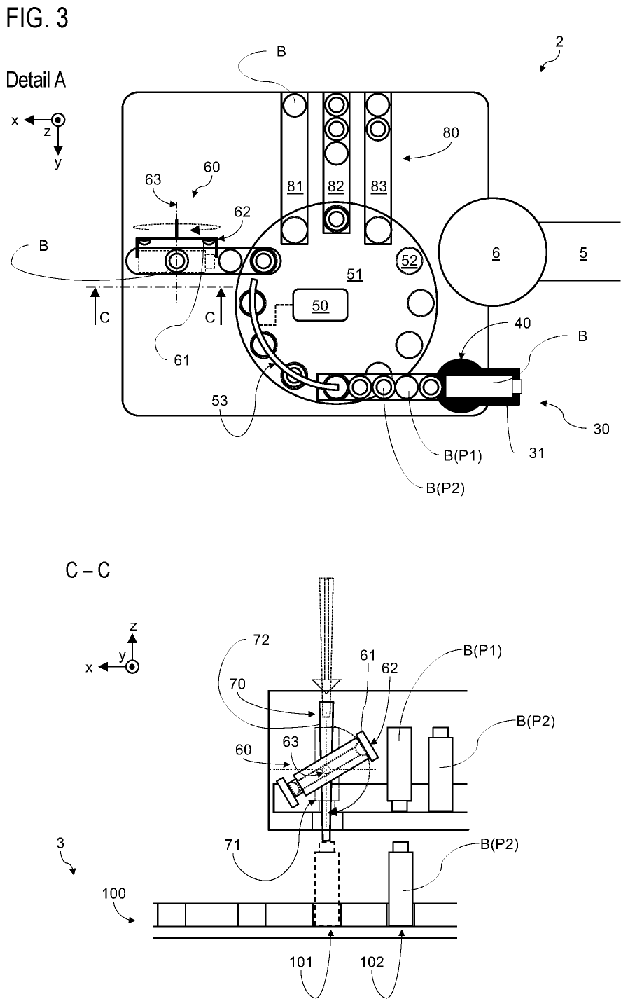

FIG. 3 shows a schematic detailed view of a mounting device of the assembly arrangement according to FIG. 2.

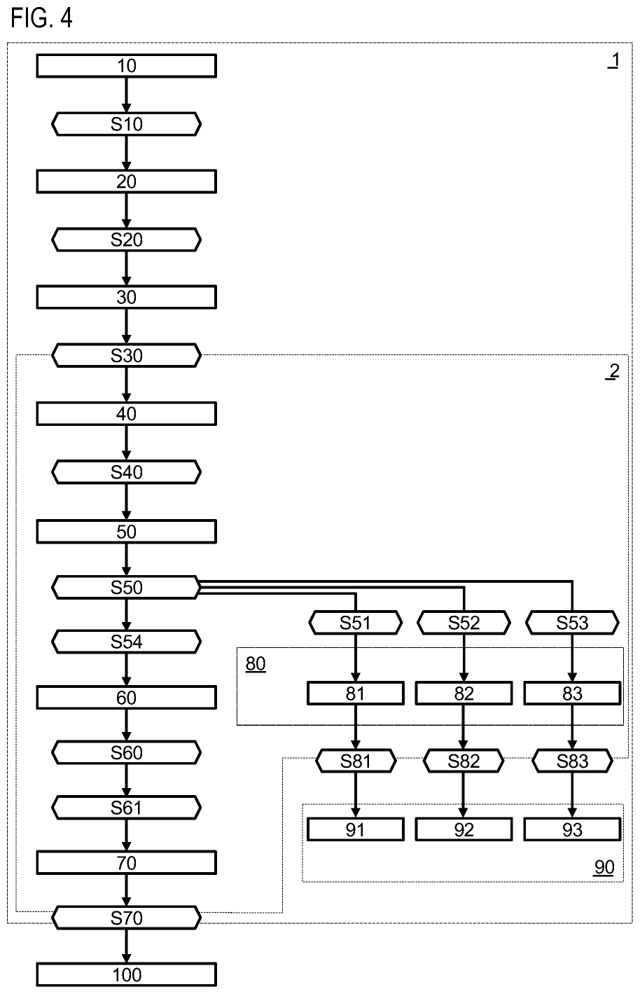

FIG. 4 shows a flow chart explaining a method according to an exemplary embodiment for fitting a battery pack with battery cells by means of the assembly arrangement according to FIGS. 2 and 3.

In the following description, reference is made to the accompanying drawings, which form part of the disclosure and in which specific aspects are shown for illustration purposes, in which the present disclosure can be understood. In the following descriptions, identical reference signs refer to identical or at least functionally or structurally similar features.

Generally, a disclosure about a described method also applies to a corresponding device to perform or make the method, or to a corresponding system comprising one or more devices, and vice versa. For example, when a particular method step is described, a corresponding device may comprise a feature to perform the described method step, even if this feature is not explicitly described or illustrated. On the other hand, if, for example, a particular device is described on the basis of functional units and/or structural features, a corresponding method may comprise a step which performs the described functionality or with which a corresponding structure can be produced, even if such steps are not explicitly described or illustrated. Similarly, a system may be provided with corresponding device features or with features to perform a particular method step. Features of the various aspects and embodiments described above or below may be combined with each other, unless explicitly stated otherwise.

In the following description, reference is made to the accompanying drawings, which form part of the disclosure and in which specific aspects are shown for illustration purposes, in which the present disclosure can be understood. In the following descriptions, identical reference signs refer to identical or at least functionally or structurally similar features.

Generally, a disclosure about a described method also applies to a corresponding device to perform or make the method, or to a corresponding system comprising one or more devices, and vice versa. For example, when a particular method step is described, a corresponding device may comprise a feature to perform the described method step, even if this feature is not explicitly described or shown. On the other hand, if, for example, a particular device is described on the basis of functional units and/or structural features, a corresponding method may comprise a step which performs the described functionality or with which a corresponding structure can be produced, even if such steps are not explicitly described or illustrated. Similarly, a system may be provided with corresponding device features or with features to perform a particular method step. Features of the various aspects and embodiments described above or below may be.

FIG. 1 shows a placement device of an embodiment of the present disclosure, wherein the placement device is shown in various states a) to e). These states can be assumed during a placement process by which a placement item B is moved to a target position 101. In a state a), an item B, for example a battery cell, is already arranged in the correct orientation on a straight axis 74. The axis 74 is directed towards the target position 101. A force in the vertical direction is required to move the component B to the target position 101. This force is applied by the placement effector 70. In particular, the placement effector 70 can be designed as a cylindrical wedge, which is struck or pressed against the placement item from above in order to move it to the target position 101. During this process, however, the placement effector 70 in particular can also apply forces to the placement material B which are not directed exactly along the axis 74. However, to ensure that the placement item B is moved precisely in the direction of the target position 101, a guide sleeve 73 is arranged between the target position 101 and the placement item B (in state a). The positioning force initially moves the item B into the guide sleeve 73. If the placement material B deviates from the axis 74 in its path, the sleeve 73 applies guiding forces to the placement material B. In state b), the placement effector 70 has already applied a force to the placement material B and conveyed it through the guiding sleeve 73 into the target position. The placement device must then be moved back to an initial position in such a way that the placement material B remains in the target position 101. In state c), the guiding sleeve 73 is first moved upwards. This takes place while the placement effector 70 applies a positioning force to the placement item B. This ensures that the placement material B does not adhere to the guiding sleeve 73 and is removed from the target position 101 by moving the guiding sleeve 73 again. After the guiding sleeve 73 has been moved away from the placement material B, the placement effector 70 can also be moved back to its starting position. This is shown in state d). After both the sleeve 73 and the placement effector 70 have been removed from the placement material B, the placement device is moved to a new target position 102. A placement item can then be conveyed to the target position 102.

FIG. 2 shows an exemplary assembly arrangement 1 for fitting a battery pack 100 with battery cells B, for example of type 18650, 20650 and/or 21700. The assembly arrangement 1 has a cell storage 10 for the unordered provision of the battery cells B to be assembled at an assembly location 3.

Furthermore, the assembly arrangement 1 has a cell separator 20 for individually removing the battery cells B from the cell storage 10.

In the embodiment example, the cell separator 20 has a step conveyor 21 that is capable of separating the completely unsorted cylindrical battery cells B with great reliability (virtually error-free) and feeding them to a further conveyor by means of the conveyor 30.

For this purpose, the cell store 10 has an inclined plane with an inclination towards the lowest step 22 of the step conveyor 21. This ensures that more and more battery cells B are fed to the step conveyor 21 by itself (i.e. due to the effect of gravity) until the last battery cell B provided in the cell store has been separated and conveyed further.

Furthermore, the assembly arrangement 1 has a mounting device 2, which is explained in more detail in particular with regard to FIG. 3, and by means of which the battery cells B can be inserted into the battery pack 100 individually and aligned as desired with regard to their polarity P1 or P2.

Furthermore, the assembly arrangement 1 has an industrial robot 4 with a robot arm 5 for arranging and moving the placement device 2. This in itself can be expertly selected according to the requirements of the operation of the placement device 2 in the embodiment example.

Furthermore, the assembly arrangement 1 has a conveyor 30 for conveying the separated battery cells B from the cell separator 20 to the placement device 2.

The conveying means 30 has an at least substantially cross-sectionally stable but flexible tube 31 for guiding the individual battery cells B along a longitudinal axis of the tube 31.

A filling device 33 of the conveyor 30 is provided at a transfer position 32 between the uppermost stage 23 of the step conveyor 21 and an inlet of the hose 31. An insertion arrangement 34 of the filling device 33 pushes an individual battery cell B from the uppermost stage 23 of the step conveyor 30 into the hose 31 for each cycle.

In this way, the battery cells B previously separated with the cell separator 30 can be fed to the placement device 2. The use of the flexible hose 31 makes it possible to separate the battery cells B at the cell separator 20 in a fixed position, although the battery cells B are required at the placement device 2 in a flexible position depending on the current position of the robot arm 5.

Such an assembly arrangement 1 requires a much smaller installation space than known assembly arrangements, which require more space for the orderly provision of the battery cells to be assembled in a cell store for pole-aligned battery cells.

FIG. 3 shows the mounting device 2 of the assembly arrangement 1 in FIG. 2. The section of FIG. 2 shown in FIG. 3 is labeled “Detail A”.

The placement device 2 has a robot interface 6 for holding the placement device 2 on the robot arm 5 of the industrial robot 4.

Furthermore, the mounting device 2 has a cell interface 40 for transferring battery cells from the tube 31 of the conveyor means 30. In the embodiment example, the cell interface 40 is designed such that the battery cells B removed from the tube 31 can be positioned next to each other with respect to their respective longitudinal axis so that they can then be transferred individually to a test means 50. Alternatively, the cell interface 40 can also be designed in such a way that the battery cells B are transferred directly from the tube 31 into the test means 50.

Furthermore, the mounting device 2 has a test means 50 for checking various electrical and/or electronic and/or structural-mechanical quality parameters of the battery cells to be removed.

This makes it possible to provide untested battery cells B because it can be determined in the test means 50 which of the battery cells B provided individually achieve the required quality and can therefore be installed in the battery pack 100.

The test means 50 is set up to test more than one battery cell B at the same time. This ensures that there is sufficient time to test each individual battery cell B.

In the embodiment example, the test means 50 has a turret holder 51 with several cell holders 52 for the battery cells B to be tested, which are evenly spaced from each other in the circumferential direction. With the turret holder 51, a continuously fillable and emptiable intermediate storage for battery cells B can be realized, in which the battery cells B can be tested for more than one cycle time by means of a test head 53. In the embodiment example, the turret holder 51 is designed and arranged in the placement device 2 in such a way that, for example, four battery cells B can be tested simultaneously.

Furthermore, the placement device 2 has a reject device 80 for battery cells B that have been rejected by the test means, i.e. tested not in order (n.i.O.). This allows battery cells B with an unsatisfactory test result to be sorted out.

The ejection device 80 is set up to feed the ejected battery cells to a reject store 90 of the assembly arrangement 80, in particular by a suitable movement of the robot arm 5. This can ensure that the rejected battery cells B can be fed to a further use, for example in a battery pack with lower requirements for the quality of the battery cells B used.

In the embodiment example, the ejection device 80 is set up to feed the ejected battery cells B to a specific one of a plurality of trays 91, 92, 93 in the reject store 90. In the embodiment example, the reject store 90 of the assembly arrangement 1 thus has three separate trays 91, 92 and 93; the ejection device 80 has three separate ejection means 81, 82 and 83 for this purpose. This makes it possible to store a certain number of sorted-out battery cells B in the separate ones before the robot arm 5 has to move to the reject store 90.

Of course, in another, otherwise unchanged embodiment example, only one ejection means can be provided. However, the robot must then move to the reject store 90 each time a rejected battery cell B is to be ejected.

In this way, the test result of the battery cells B can be taken into account in a differentiated manner: for example, battery cells B that can still be used in other battery packs with lower quality requirements can be separated from battery cells B that are complete rejects based on the test result. This also ensures that only battery cells that are necessary for the intended assembly are aligned.

Furthermore, the mounting device 2 has a cell aligner 60 for aligning the battery cells B that have been tested in order (i.O.). The alignment is carried out before the battery cell B is discharged to a designated pole location P1 or P2.

The cell aligner 60 has a pole location detection 61 which, in cooperation with an undisplayed control unit of the assembly arrangement 1, is set up to recognize the current pole location P2 of the battery cell B on arrival of the battery cell B at a discharge position 71 and to compare it with a pole location P1 of the battery cell B required at the intended mounting position 101 of the battery pack 100 and, if necessary, to carry out an alignment, in particular rotation, of the battery cell towards the required pole location P1 by means of an alignment means 62.

A required pole position P1 or P2 of a battery cell B at an intended placement location 101 is stored for all placement locations in the control unit of the assembly arrangement 1, which is not shown, in a read-in placement plan, which the control unit requires anyway for the placement of the battery pack 100.

In the embodiment example, the cell aligner 60 is set up to rotate the battery cell B about an axis 63 in the middle of a longitudinal extension of the battery cell with positional accuracy by means of the alignment means 62, whereby the axis 63 runs perpendicular to a longitudinal axis L of the battery cell and intersects the longitudinal axis. This makes it possible to align the pole position of the battery cell in a very confined space.

As can be clearly seen in particular in the sectional view C-C in FIG. 3, the placement device 2 also has a placement effector 70 for discharging the battery cell B arranged in the required pole position at the discharge position 71 into the battery pack 100 at the placement location 101. For this purpose, the placement effector 70 has an ejector arrangement 72 which discharges an aligned battery cell B for each cycle.

When using this exemplary mounting device 2 in an exemplary assembly arrangement 1, the battery cells B can be provided completely unsorted, as indicated in FIG. 2. This means an enormous saving in staging areas for the battery cells B to be installed. In addition, by aligning the battery cells in a pole position P1 or P2 on the placement device 2, i.e. on the robot arm 5, the placement can be carried out with a shorter cycle time because the travel distances between the individual placement points 101 and 102 are minimized.

FIG. 4 shows an exemplary method for fitting a battery pack 100 with battery cells B by means of the assembly arrangement 2 described with respect to FIGS. 2 and 3.

The exemplary method has the following steps S, which are carried out in particular in the sequence shown in FIG. 4:

S10: Unaligned and disorganized provision of the battery cells B to be assembled in the cell store 10.

S20: Removal and thus separation of individual and (with regard to their pole location P) unaligned battery cells B from the cell storage 10 by means of the cell separator 20.

S30: Conveying the removed, separated and unaligned battery cells B from the cell separator 20 to the mounting device 2 by means of the conveyor 30.

S40: Insertion of the battery cells B conveyed to the placement device 2 into the test means 50, in particular at or after passing the cell interface 40.

S50: Testing the battery cells B: Checking one or more electrical and/or electronic and/or structural-mechanical quality parameters of the battery cells B intended for assembly by means of the test means 50.

If a tested battery cell B is assigned the test result “passed” (i.e. “OK”), the battery pack 100 is then fitted with this battery cell B. If the test results in “OK”, step S50 is followed by steps S54 to S70:

S54: Insert the battery cell B that has been tested and found to be “OK” into the cell aligner 60.

S60: Checking the pole location P of the battery cell B and comparing it with a desired pole location P stored in the control unit in the cell aligner 60.

S61: If the check of the battery cell P of the battery cell B shows that it does not have the desired pole location P1 or P2, align the battery cell B to the desired or intended pole location P2 or P1 using the cell aligner 60.

S70: Discharge of the battery cell B, aligned, if necessary, into the battery pack 100 to the intended placement location 101 by means of the ejector arrangement 72.

If a tested battery cell B is assigned the test result “failed” (i.e. “n.i.O.”) and the battery cell B is, then sent to a reject store 90. If the result of the test in step S50 is “n.i.O.”, steps S51 and S81 or S52 and S82 or S53 and S83 follow step S50:

In the exemplary procedure, the result of the quality test from step S50 contains a statement about a level of failure of the test.

A test result “n.i.O. Level 1” is awarded to battery cells B that do not quite meet the requirements of the battery pack 100 to be fitted but can certainly be installed in other battery packs with lower quality requirements. Battery cells B with the test result “n.i.O. Level 1” go through the following process steps:

S51: Insertion into the first ejector 81 for level 1 shot from the turret holder 51.

S81: Dropping the battery cell B into the first tray 91 for level 1 rejects in the reject store 90.

A test result “n.i.O. Level 2” is awarded to battery cells B that cannot be installed in battery packs but can be used in everyday applications with low quality requirements. Battery cells B with the test result “n.i.O. Level 2” go through the following process steps:

S52: Insertion into the second ejector 82 for level 2 ejection from the turret 52.

S82: Dropping the battery cell B into the second tray 92 for level 2 rejects in the reject store 90.

A test result “n.i.O. Level 3” is assigned to battery cells B that cannot be used any further. Battery cells B with the test result “n.i.O. Level 3” go through the following process steps:

S53: Insertion into the third ejector 83 for level 3 ejection from the turret holder 53.

S83: Dropping battery cell B into the third tray 93 for level 3 rejects in reject store 90.

In this way, different quality levels of the battery cells B can be distinguished during testing and installed in the battery pack according to the determined quality level “OK”, or according to the determined quality level “NOK”. Level 1″, “n.i.O. Level 2” and, “n.i.O. Level 3” or discarded in the various trays 91, 92 and 93 of the reject store 90.

With the exemplary method, an enormous saving can be achieved in terms of staging areas for the battery cells B to be installed. In particular, when assembling battery packs 100 from a large number of battery cells B, the provision of the battery cells B is much simpler and thus also cheaper. In addition, the exemplary method enables a shorter cycle time when assembling the battery pack 100 with battery cells B.

### REFERENCE LIST

B Battery cell
P1 First pol location
P2 Second pol location
1 Assembly arrangement
2 Mounting device
3 Assembly location
4 Industrial robot
5 Robot arm
6 Robot interface
10 Cell storage
20 Cell separator
21 Stage conveyor
22 Lowest level
23 Top level
30 Conveyor means
31 Hose
32 Transfer position
33 Filling device
34 Slide-in arrangement
40 Cell interface
50 Test means
51 Revolver mount
52 Cell uptake
53 Test head
60 Cell aligners
61 Pole location detection
62 Aligner
63 Alignment axis of the cell aligner
70 Placement effector
71 Discharge position
72 Sliding arrangement
73 Guide sleeve
74 Axial direction of the positioning force
80 Ejector
81 Discharge means
82 Second discharge means
83 Third discharge means
90 Scrap warehouse
91 First shelf
92 Second shelf
93 Third shelf
100 Battery pack
101 Placement point, target position
102 Placement point, target position
S10 Providing the battery cells
S20 Separating the battery cells
S30 Conveying the battery cells
S40 Inserting the battery cells into the test means
S50 Testing the battery cells
S51 Insertion of level 1 scrap into the discharge medium
S52 Insertion of level 2 scrap into the discharge medium
S53 Insertion of level 3 scrap into the discharge medium
S54 Inserting battery cells into the cell aligner
S60 Checking the pole location of the battery cell
S61 Align the battery cell if necessary
S70 Discharging the aligned battery cell into the battery pack
S81 Discarding level 1 scrap
S82 Discarding level 2 scrap
S83 Discarding level 3 scrap

1. Mounting device, in particular for mounting a battery pack, configured to:
pick up a provided placement item, in particular battery cells;
apply an axial positioning force to the placement material in order to convey the placement material into a target position, in particular into a battery cell receiver;
apply a radial guiding force to the placement material in order to convey the placement material into the target position;
apply the guiding force independently of the positioning force.

2. The mounting device according to claim 1, configured to reduce the guiding force before the positioning force, in particular to reduce it completely.

3. The mounting device according to claim 1, configured to check one or more quality parameters of the placement item and, depending on the check, to apply the positioning force and/or the guiding force or to eject the placement item from the mounting device.

4. The mounting device according to claim 1, configured to simultaneously check a plurality of placement items.

5. The mounting device according to claim 1, configured to convey the placement item in a predetermined orientation into the target position.

6. The mounting device according to claim 1, comprising a mechanically flexible connection for receiving the provided placement item.

7. The mounting device according to claim 1, wherein the positioning force is applied non-uniformly in order to convey the placement item to the target position.

8. The mounting device according to claim 1, configured to apply the guiding force by means of a guide sleeve and/or a guide rail, along which the placement item is conveyed by the positioning force and wherein the guide sleeve and/or the guide rail is moved laterally relative to the target position to a position whose distance from the target position is less than a length of the placement item.

9. Mounting device for mounting a battery pack with battery cells, comprising
an interface for receiving the placement device by a positioning unit, in particular an industrial robot,
a cell interface for receiving battery cells from a conveyor means, and/or
a cell aligner for aligning the battery cells in a specific pole location, and/or
a placement effector for discharging the battery cells into the battery pack, for applying an axial positioning force to the aligned battery cell;
a battery cell guide for applying a radial guiding force to the aligned battery cell;
wherein the placement effector and the battery cell guide are configured to apply the axial positioning force and the radial guiding force independently of each other.

10. The mounting device according to claim 1, wherein the cell aligner and the battery cell guide form an integrated means.

11. The mounting device according to claim 9, further comprising a test means for checking one or more quality parameters of the battery cells to be discharged.

12. The mounting device according to claim 11, wherein the test means is set up to test more than one battery cell simultaneously and/or overlapping in time.

13. The mounting device according to claim 9, wherein the cell aligner:
is arranged at a discharge position of the mounting device, and/or
comprises a pole location detection which is configured to detect a pole location of the battery cell and/or to compare it with a pole location required at the intended mounting location of the battery pack and, if necessary, to carry out an alignment, in particular rotation, of the battery cell towards the required pole location, and/or
is configured to rotate a battery cell about an axis which runs perpendicular to a longitudinal axis of the battery cell.

14. Assembly arrangement for fitting a battery pack with battery cells, comprising:
a cell store for providing the battery cells to be assembled in an unordered manner,
a cell separator for the individual removal of the battery cells from the cell store,
an mounting device according to claim 1,
an industrial robot with a robot arm for arranging and/or moving the assembly device,
a conveying means for conveying the separated battery cells from the cell separator to the mounting device,
a cell aligner for aligning the battery cells.

15. Method for assembling a battery pack with battery cells, comprising the following steps:
providing the battery cells to be assembled in a cell store,
separating battery cells from the cell store,
conveying the separated battery cells to an mounting device,
if necessary, aligning the battery cells in a specific pole location,
discharging the aligned battery cells into a battery pack, the discharge being effected by an axial force on the battery cells and by a radial force, which are independent of one another.

16. The method according to claim 15, comprising the method step:
checking one or more quality parameters of the battery cells intended for mounting, wherein, depending on the check, the respective battery cell is sent to a scrap store.
